(19) United States
(12) Patent Application Publication
(10) Pub. No.: US 2026/0339306 A1
(43) Pub. Date: Oct. 29, 2026

(54) QUALITY ABNORMALITY FACTOR ANALYSIS SUPPORT SYSTEM

(71) Applicant: TMEIC Corporation, Tokyo (JP)

(72) Inventor: Masayasu SEKIMOTO, Tokyo (JP)

(73) Assignee: TMEIC Corporation, Tokyo (JP)

(21) Appl. No.: 18/995,167

(22) PCT Filed: Jul. 12, 2023
(86) PCT No.: PCT/JP2023/025756

§ 371 Date: Jan. 16, 2025

(51) Int. Cl. G05B 19/418

(52) U.S. Cl. CPC G05B 19/41875; G05B 2219/32194

(57) ABSTRACT

A data storage unit stores manufacturing conditions for products, setting conditions for facilities and equipment, and time-series data at the time of manufacture as record data acquired from measurement equipment. A quality abnormality factor estimation/calculation unit obtains quality abnormality positions of such abnormal products that quality evaluation values calculated from quality data exceed a tolerance, constructs a quality abnormality factor estimation model based on time-series data about a normal product group, or the manufacturing conditions and the setting conditions, estimates factor candidates of the quality abnormality based on the constructed quality abnormality factor estimation model, and calculates degrees of relationships of the estimated factor candidates with the quality abnormality. A display information generation unit generates information for displaying the quality data of the abnormal products, the quality abnormality positions, the time-series data, or the manufacturing conditions and the setting conditions, and the factor candidates and the degrees of relationships.

### TECHNICAL FIELD

The present disclosure relates to a quality abnormality factor analysis support system. In particular, the present disclosure relates to a quality abnormality factor analysis support system for, when a product such as a steel plate manufactured in a rolling plant is judged to have a quality abnormality, supporting work for analyzing factors of the quality abnormality.

### BACKGROUND ART

If a product manufactured in a rolling plant does not satisfy quality control standard values specified in response to a request and the like from a customer, the product is determined to have a quality abnormality (including a poor quality). In PTL 1 below, a manufacturing process abnormality judgment apparatus is disclosed.

A product determined to have a quality abnormality is sold as a low-grade material or handled as being to be scrapped, which causes decrease in production efficiency. When a quality abnormality occurs, it is necessary to determine the characteristics thereof, conduct analytical research of the factors, and decide and implement measures such as change in operation conditions and control settings for preventing recurrence.

Since the series of works from the determination of the characteristics of the quality abnormality to the implementation of the measures requires an experienced expert to making a comprehensive determination from a large number of pieces of data and information, a lot of effort and time is required. In PTL 2 below, a quality abnormality cause estimation system is disclosed.

### CITATION LIST

### Patent Literature

[PTL 1] JP 6116445 B
[PTL 2] JP 4365536 B

### SUMMARY OF THE INVENTION

### Problems to be Solved by the Invention

In PTL 2, a group of such products that conditions for various input information at the time of manufacture are mutually close is found, and a quality abnormality can be detected beforehand based on whether an output result corresponds to the trend of output results of the group of products. Further, it is possible to, based on a difference between a representative value or the like among the output results of the group of products having the close input information conditions and a prediction result computed based on input information about a target product, improve the accuracy of predictive computation for the target product.

PTL 2, however, is specialized in detection of a quality abnormality for manufacturing conditions and setting conditions for each product and analysis of the factors thereof. Therefore, in PTL 2, it is not possible to grasp at which position in the longitudinal direction of a product a quality abnormality has occurred. This is due to the fact that, since a product is long in its longitudinal direction, and the amount of information of time-series data (record data) is too much, it is common to compress the time-series data to detect a quality abnormality. Therefore, when a quality abnormality occurs, work for identifying a position of the occurrence of the quality abnormality and then analyzing the factors of the occurrence at the identified occurrence position is required.

The present disclosure has been made to solve the problem as described above. An object of the present disclosure is to provide a quality abnormality factor analysis support system capable of, when a product is judged to have a quality abnormality, displaying at which position in the longitudinal direction of the product the quality abnormality has occurred and displaying the factors of the occurrence.

### Solution to Problem

A first aspect relates to a quality abnormality factor analysis support system. The quality abnormality factor analysis support system comprises a data storage unit, a quality abnormality factor estimation/calculation unit, and a display information generation unit. The data storage unit stores manufacturing conditions for products manufactured in a rolling plant, setting conditions for facilities and equipment installed in the rolling plant, and time-series data at time of manufacture as record data acquired from measurement equipment installed in the rolling plant. The quality abnormality factor estimation/calculation unit calculates quality evaluation values from quality data about product qualities of the products selected from the time-series data at the time of manufacture, regarding such products or a product group that the calculated quality evaluation values exceed a tolerance as abnormal products, and obtains quality abnormality positions of the abnormal products at which the tolerance is exceeded. The quality abnormality factor estimation/calculation unit constructs a quality abnormality factor estimation model based on the time-series data about a normal product group the quality evaluation values of which are within the tolerance or based on the manufacturing conditions and the setting conditions, estimates factor candidates of the quality abnormality from the time-series data or from the manufacturing conditions and the setting conditions, based on the constructed quality abnormality factor estimation model, and calculates degrees of relationship of the estimated factor candidates with the quality abnormality. The display information generation unit generates information for displaying, on a display unit, the quality data of the abnormal products, the quality abnormality positions, the time-series data, or the manufacturing conditions and the setting conditions, and the factor candidates and the degrees of relationship estimated and calculated by the quality abnormality factor estimation/calculation unit.

A second aspect further includes the following characteristics in addition to the first aspect. The display information generation unit generates information for displaying the manufacturing conditions, the setting conditions, the quality evaluation values, and the quality abnormality positions, for the abnormal products, in a list.

A third aspect further includes the following characteristics in addition to the first aspect. The display information generation unit generates information for displaying trend charts of the quality data of the abnormal products, a trend chart of the time-series data corresponding to the factor candidate with a highest degree of relationship among the factor candidates estimated by the quality abnormality factor estimation/calculation unit, and the quality abnormality positions in each of the trend charts.

A fourth aspect further includes the following characteristics in addition to the first aspect. The display information generation unit generates information for displaying trend charts of the quality data of the abnormal products, the plurality of factor candidates estimated by the quality abnormality factor estimation/calculation unit, the degree of relationship of each factor candidate, a trend chart of the time-series data corresponding to each factor candidate, and the quality abnormality positions in each of the trend charts.

A fifth aspect further includes the following characteristics in addition to the first aspect. The display information generation unit generates, for the abnormal products the quality data and quality abnormality positions of which are the same, information for displaying the setting conditions as the factor candidates and degrees of relationships of the setting conditions with the quality abnormality.

A sixth aspect further includes the following characteristics in addition to the first aspect. The quality abnormality factor estimation/calculation unit uses machine learning or a statistical method as the quality abnormality factor estimation model.

A seventh aspect further includes the following characteristics in addition to the first aspect. The quality abnormality factor estimation/calculation unit reconstructs the quality abnormality factor estimation model each time each of the products is manufactured, and, when a predicted error of the reconstructed quality abnormality factor estimation model is smaller than a predicted error of the quality abnormality factor estimation model before the reconstruction, updates the quality abnormality factor estimation model.

### Advantageous Effects of the Invention

According to the present disclosure, it is possible to, by obtaining a quality abnormality position at which a quality evaluation value of an abnormal product exceeds a tolerance, display at which position in the longitudinal direction of the product the quality abnormality has occurred. Furthermore, by constructing a quality abnormality factor estimation model using normal data, estimating factor candidates of the quality abnormality using the constructed quality abnormality factor estimation model, and calculating degrees of relationship of the estimated factor candidates with the quality abnormality, it is possible to display time-series data with a high degree of relationship as the factor of the occurrence of the quality abnormality. Therefore, it is possible to provide a quality abnormality factor analysis support system capable of, when a product is judged to have a quality abnormality, displaying at which position in the longitudinal direction of the product the quality abnormality has occurred and displaying the factor of the occurrence.

### BRIEF DESCRIPTION OF DRAWINGS

FIG. 1 is a schematic diagram showing an example of a rolling plant to which a quality abnormality factor analysis support system according to a first embodiment is applied.

FIG. 2 is a diagram showing a configuration of data collected and registered by a data storage unit.

FIG. 3 is a diagram showing a process flow of the quality abnormality factor analysis support system according to the first embodiment.

FIG. 4 shows examples of a configuration of an input variable and an output variable for a quality abnormality factor estimation model.

FIG. 5 is a diagram showing various screens displayed on an HMI apparatus with information generated by a display information generation unit.

FIG. 6 is a diagram schematically showing the content of display on a steel plate information list screen.

FIG. 7 is a diagram schematically showing the content of display on a screen popup-displayed on the steel plate information list screen.

FIG. 8 is a diagram schematically showing the content of display on a quality abnormality factor estimation result display screen.

FIG. 9 is a diagram schematically showing the content of display on a similar quality abnormality factor estimation/analysis screen.

FIG. 10 is a diagram schematically showing the content of display on a quality abnormality factor/setting analysis display screen.

FIG. 11 is a diagram showing a process flow of the quality abnormality factor analysis support system according to a second embodiment.

FIG. 12 is a diagram showing an example of the hardware configuration of the quality abnormality factor analysis support system.

### DESCRIPTION OF EMBODIMENTS

A quality abnormality factor analysis support system according to embodiments of the present disclosure will be described below with reference to the drawings. Components common to figures will be given the same reference signs, and duplicated description will be omitted.

### First Embodiment

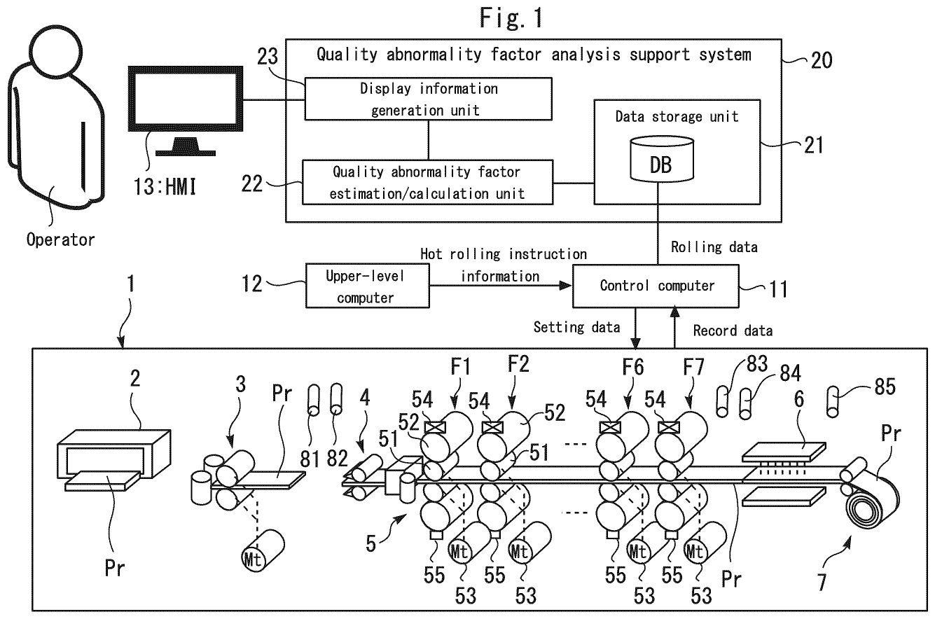

FIG. 1 is a schematic diagram showing an example of a rolling plant 1 to which a quality abnormality factor analysis support system 20 according to a first embodiment is applied.

Though the rolling plant 1 is, for example, a hot rolling plant having a hot rolling line, it may be a cold rolling plant. In the rolling plant 1, a heating furnace 2, a roughing mill 3, a crop shear 4, a finishing mill 5, a cooling apparatus 6, and a coiler 7 are installed as main facilities and equipment constituting the hot rolling line. In the rolling plant 1, a conveyance table (not shown) for conveying a steel plate Pr among the pieces of rolling equipment is installed. These pieces of rolling equipment are driven by an electrical system such as a motor or an actuator.

The heating furnace 2 is configured to heat the steel plate (slab) Pr before being rolled to a predetermined temperature (for example, 1200 °C). The roughing mill 3 has at least one (generally one to three) rolling stand and performs multiple-pass rolling of the steel plate (slab) Pr heated by the heating furnace 2 in a forward direction (from upstream to downstream of the rolling line) and an opposite direction (from downstream to upstream of the rolling line). The crop shear 4 cuts a bad shape part existing at a head end part or a tail end part of the steel plate Pr with upper and lower blades, based on a shape measured by a shape detector 81 to be described later. The finishing mill 5 is a tandem rolling mill provided with, for example, seven rolling stands F1 to F7 that are provided in parallel in the rolling direction of the steel plate Pr. Each of the rolling stands F1 to F7 is provided with two upper and lower work rolls 51, two upper and lower backup rolls 52, and a motor 53 for rotating the rolls. Reduction devices 54 are provided on the backup rolls 52, and a configuration is made so that a gap between the upper and lower work rolls 51 can be adjusted by the reduction devices 54. Rolling loads of the rolling stands F1 to F7 are measured by rolling load sensors 55, respectively. The cooling apparatus 6 cools the steel plate Pr by pouring water onto the steel plate Pr from a cooling bank. The cooled steel plate Pr is wound into a coil shape by the coiler 7.

At key points of the rolling plant 1, various kinds of sensors as measurement equipment are installed. The key points of the rolling plant 1 are, for example, the delivery side of the heating furnace 2, the delivery side of the roughing mill 3, the delivery side of the finishing mill 5, and the entry side of the coiler 7. Various kinds of sensors are also provided among the rolling stands F1 to F7 of the finishing mill 5. The various kinds of sensors include the shape detector 81 capable of measuring the shape of the steel plate Pr at the delivery side of the roughing mill 3, a pyrometer 82 that measures the surface temperature of the steel plate Pr at the entry side of the finishing mill 5, a speed detector 83 that measures a speed Va of the steel plate Pr at the delivery side of the finishing mill 5, a plate thickness/width meter 84 that measures the plate thickness and the plate thickness of the steel plate Pr at the delivery side of the finishing mill 5, a pyrometer 85 that measures the surface temperature of the steel plate Pr at the entry side of the coiler 7, and the rolling load sensors 55 described above. The various kinds of sensors sequentially measure the states of the steel plate Pr and the facilities and equipment. Record data measured by the various kinds of sensors is transmitted to a control computer 11 moment by moment. Therefore, the record data is time-series data.

The rolling plant 1 is driven (operated) by a control system using a computer having a hierarchical structure. The computer includes the process control computer (hereinafter referred to as “the control computer”) 11 and an upper-level computer 12 that are mutually connected via a network. The control computer 11 is connected to the quality abnormality factor analysis support system 20 to be described later, via a network. The control computer 11 has a control controller such as a PLC (Programmable Logic Controller). To the control computer 11, an HMI (Human Machine Interface) apparatus 13 is connected via the network. A configuration is made so that, by presenting data of a monitoring target (the pieces of rolling equipment) to the HMI 13, a user (including an administrator) can monitor or operate (control) a monitoring target apparatus. When hot rolling instruction information, which is a rolling plan, is inputted to the upper-level computer 12 by a designer of the rolling plan, the hot rolling instruction information is sent from the upper-level computer 12 to the control computer 11. The hot rolling instruction information includes a target plate thickness, a target plate width, target temperatures, and the like. The target temperatures include a target temperature at the delivery side of the finishing mill 5 (hereinafter referred to as “the finisher delivery-side temperature”) and a target temperature at the entry side of the coiler 7 (hereinafter referred to as “the coiling temperature”), and the like. By, in response to input of the hot rolling instruction information (the rolling plan), which is manufacturing conditions, from the upper-level computer 12, computing design data that includes setting values of the pieces of rolling equipment, which are control targets, and transmitting the computed design data to the rolling plant 1, the process control computer 11 executes control of the various kinds of rolling equipment.

The quality abnormality factor analysis support system 20 collects data (rolling data) transferred between the pieces of rolling equipment of the rolling plant 1 and the upper-level computer 12, computes information for supporting quality abnormality factor analysis using the collected rolling data, and provides the information for the user (including the administrator).

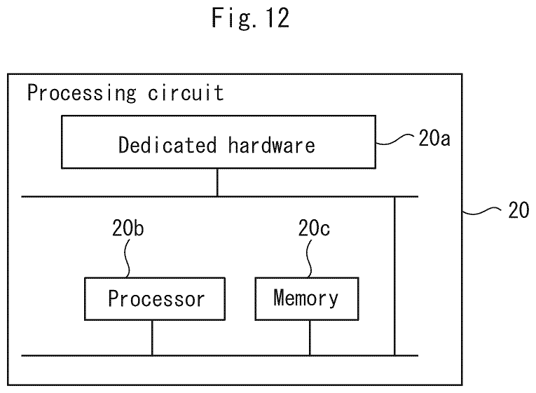

The quality abnormality factor analysis support system 20 is provided with a data storage unit 21, a quality abnormality factor estimation/calculation unit 22, a display information generation unit 23. Functions of the units 21 to 23 of the quality abnormality factor analysis support system 20 can be realized, for example, by a processor 20b shown in FIG. 12 to be described later reading out and executing a program stored in a memory 20c.

The data storage unit 21 has a function of collecting rolling data and storing the rolling data into a database DB. The rolling data includes the hot rolling instruction information, setting data and record data described above. The quality abnormality factor estimation/calculation unit 22 performs calculation (computation) of information for supporting evaluation of product quality and analysis of quality abnormality factors based on a result of the evaluation, using the rolling data stored in the data storage unit 21. The display information generation unit 23 causes a result of the calculation by the quality abnormality factor estimation/calculation unit 22 to be displayed on the HMI apparatus 13 as a display unit. An operator confirms and operates the information (the computation result) displayed on the HMI apparatus 13 to perform analysis work.

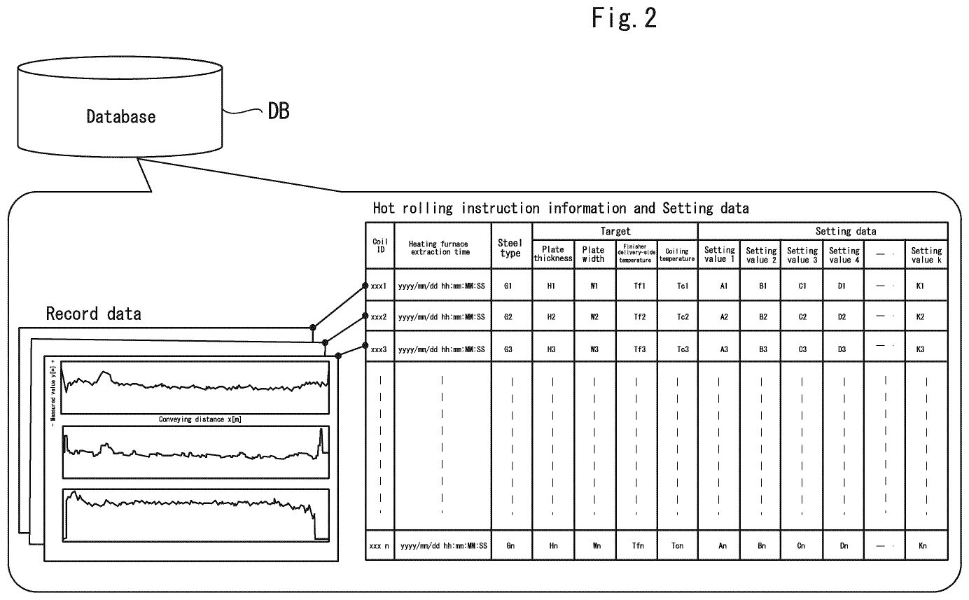

FIG. 2 is a diagram showing a configuration of data collected and registered by the data storage unit 21. As shown in FIG. 2, the information collected by the data storage unit 21 includes, for example, information assigned to each of steel plates Pr, like the hot rolling instruction information and the setting data, and time-series data obtained moment by moment for rolling of each of the steel plates Pr, like the record data. The pieces of information and data are associated with serial numbers (hereinafter referred to as “coil IDs”) of the steel plates Pr and times of extraction of the steel plates Pr from the heating furnace 2, and stored as the database DB. Though the database DB is provided inside the quality abnormality factor analysis support system 20 in the example shown in FIG. 1, the database DB may be provided outside the quality abnormality factor analysis support system 20, and the information and data may be exchanged via network connection.

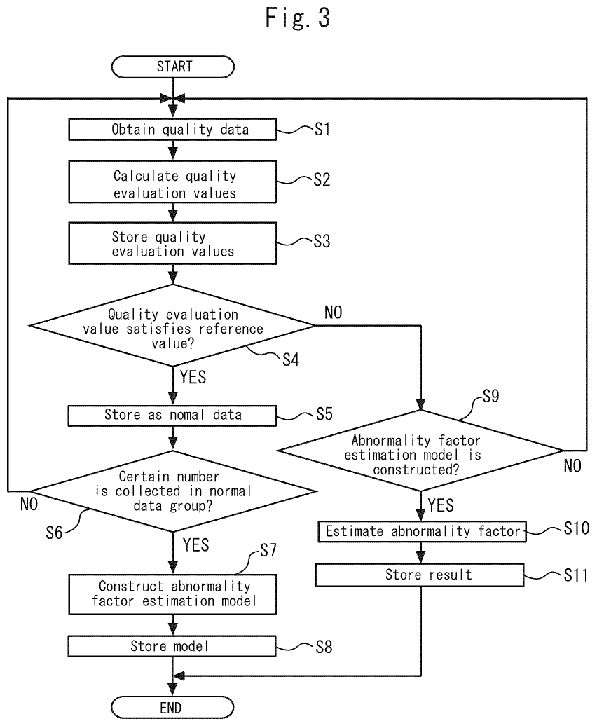

Next, description will be made on a procedure for the computation of the information for supporting product quality evaluation and quality abnormality factor analysis based on a result of the evaluation in the quality abnormality factor estimation/calculation unit 22, with reference to FIG. 3. FIG. 3 is a diagram showing a process flow of the quality abnormality factor analysis support system 20 according to the first embodiment.

First, the quality abnormality factor estimation/calculation unit 22 obtains pieces of quality data xi used for evaluation of the quality of a steel plate Pr manufactured by the rolling plant 1, for example, a finisher delivery-side plate thickness, a finisher delivery-side plate width, a shape, a finisher delivery-side temperature, and a coiler-input-side temperature, which are selected from the record data described above, which is time-series data, from the data storage unit 21 (the database DB) (step S1), and calculates quality evaluation values (step S2). Tolerances, which are reference values, are specified for the pieces of quality data xi, respectively, and the quality of the steel plate Pr is evaluated based on the tolerances. The quality evaluation values are computed, for example, by Formulas (1) and (2) below.

$$\begin{matrix}[ Math . 1 ] & \\ {performance}_{A} = \frac{( {\sum }_{i = {I}_{S}}^{{I}_{L}} {p}_{i} )}{( {I}_{L} - {I}_{S} )} \cdot 100 [ \% ] & ( 1 )\end{matrix}$$

$$\begin{matrix}[ Math . 2 ] & \\ {p}_{i} = \{ \begin{matrix}1 , & if \vert {x}_{i} \vert \leq Tolerance \\ 0 , & otherwise\end{matrix} & ( 2 )\end{matrix}$$

Here, performance_{A} indicates the quality evaluation value of any of the finisher delivery-side plate thickness, the finisher delivery-side plate width, the shape, the finisher delivery-side temperature, the coiler-input-side temperature, and the like of the steel plate Pr. Here, Iₛ and I_{L} indicate a quality evaluation value calculation target starting point relative to positions in the longitudinal direction of the steel plate and a quality evaluation value calculation target ending point relative to positions in the longitudinal direction of the steel plate, respectively. The longitudinal direction of the steel plate Pr corresponds to the rolling direction or the conveyance direction. Further, xi indicates a value of quality data at a point i between Iₛ and I_{L}, inclusive. Further, Tolerance indicates a quality reference value of any of the finisher delivery-side plate thickness, the finisher delivery-side plate width, the shape, the finisher delivery-side temperature, the coiler-input-side temperature, and the like. A length of the steel plate Pr from which the deformed unsteady parts at the head and tail ends in the longitudinal direction are excluded (so-called head and tail end cut-off) is often taken as the quality evaluation value calculation target starting and ending points in the longitudinal direction of the steel plate Pr. However, for example, the length of the steel plate Pr from which the deformed unsteady parts at the head and tail ends in the longitudinal direction are excluded may be further divided, and a quality evaluation value may be calculated for each of divided sections.

The quality evaluation values calculated at step S2 above are stored in association with the coil ID of the steel plate Pr by the data storage unit 21 (step S3). Next, it is determined whether or not each of the calculated quality evaluation values satisfies the tolerance as the reference value (step S4), and the quality evaluation value is labeled and registered in association with the coil ID of the steel plate Pr and the like as normal data of the quality if the quality evaluation value satisfies the tolerance, and as abnormal data of the quality if the quality evaluation value does not satisfy the tolerance (step S5) and stored by the data storage unit 21. The label of abnormal data of quality is not necessarily assigned for distinction from the normal data but may be registered as a label corresponding to the characteristics of abnormality. For example, when the finisher delivery-side plate thickness exceeds the tolerance, the label of abnormal data may be registered as information about whether the finisher delivery-side plate thickness is thicker than an upper limit or whether the finisher delivery-side plate thickness is thinner than a lower limit, and, furthermore, how much the deviation is. Further, by similarly registering a measurement point, that is, a position or range in the longitudinal direction of the steel plate Pr where the tolerance is exceeded, it is possible to identify at which part (position) in the longitudinal direction of the steel plate Pr the tolerance is exceeded. At this time, for example, for each of the degree of deviation from the upper limit or lower limit of the tolerance and the position or range of the measurement point where the tolerance is exceeded, a label may be registered as an index, using a numerical value range specified in advance.

It is determined whether or not an arbitrary number NL of such steel plates Pr that are labeled and registered as the normal data of target quality have been collected, that is, whether or not the certain number NL of steel plates Pr have been collected in a normal data group (step S6). When the certain number NL is exceeded, a quality abnormality factor estimation model (hereinafter also referred to as “a model”) for the target quality is constructed (step S7); the constructed model is stored by the data storage unit 21 (step S8); and the present routine ends once. When the quality evaluation value described above exceeds the tolerance after construction of the model, a determination of NO is made at step S4 above, a determination of YES is made at step S9, and the process proceeds to step S10. At step S10, an abnormality factor for the target quality is estimated using the quality abnormality factor estimation model. That is, quality abnormality factor candidates are estimated by the quality abnormality factor estimation model, and a degree of relationship between each of the estimated factor candidates and the quality abnormality is calculated. Pieces of record data estimated to be the factor candidates related to the target quality abnormality are numerically converted as “degrees of relationships”, and the item of each piece of record data and the calculated degree of relationship are stored by the data storage unit 21 in association with the coil ID of the steel plate Pr and the like.

In the present embodiment, the construction of the quality abnormality factor estimation model is limited only to the timing of the conditions described above being satisfied. After that, the construction can be performed at any timing decided by the user (including the administrator) of the quality abnormality factor analysis support system 20 as will be described in a second embodiment below.

As the quality abnormality factor estimation model described above, for example, AE (Auto Encoder), RF (Random Forest), SVR (Support Vector Regression), or the like included in the category of machine learning, or a method utilizing a statistical method may be used. Here, since the algorithms of NN, RF, and SVR are widely known, description will be simply made below.

The AE is a kind of neural network model (hereinafter referred to as “an NN model”), and is a method of detecting abnormality from a deviation between an input variable and an output variable using an NN model learned only by normal data and a data group labeled and registered (hereinafter referred to as “normal data”) so that a variable similar to the input variable is outputted. In the case of a simplest configuration, the NN model has a three-layer structure with an input layer, an intermediate layer, and an output layer, and the number of intermediate layers can be increased. By taking many intermediate layers, deep learning is enabled. Each layer is configured with one or more neurons. Each of the neurons of each layer has a weight coefficient and a bias value, and the neurons are combined. Generally, an activation function is defined for one neuron, and it is designed that the output state changes according to the level of an input value.

The RF is a method in which tree-structured weak learners are connected in parallel, the output of each of the weak learners being decided according to a plurality of input variable conditions called decision trees, and a final output is predicted by taking decision by majority or an average of the outputs of the weak learners. The SVR is a method in which a support vector machine algorithm of deciding a border line and a hyperplane to divide data into two groups is applied to a regression problem.

In all the methods, it is necessary to construct a model for performing predictive computation of an output variable from an input variable using a data group prepared for learning. In the present embodiment, a quality abnormality factor estimation model is constructed using time-series data of steel plates labeled and registered as the normal data described above or setting data of steel plates labeled and registered as the normal data.

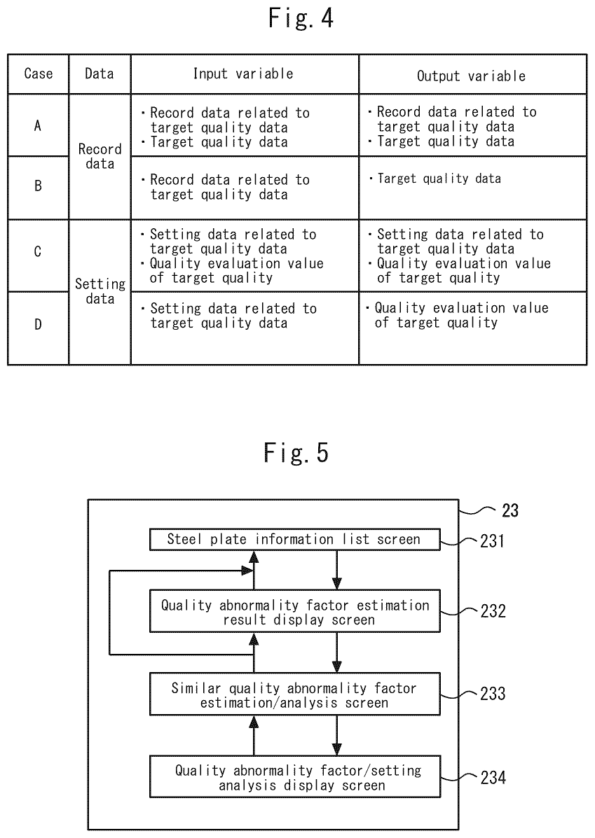

FIG. 4 shows examples of a configuration of an input variable and an output variable for the model for performing predictive computation of an output variable from an input variable. As for the input variable, there are a case of using setting data related to target quality data and a quality evaluation value as input variables (cases C and D) and a case of using record data related to target quality data and the quality data as input variables (cases A and B). Though a model for performing predictive computation of an output variable from an input variable may be constructed in any one of the above cases, models in both cases may be constructed. In the case of using quality data and record data related to the quality data (the case A), an output variable is assumed to be similar to an input variable. Here, in the RF and the SVR, only record data related to quality data is used as an input variable (case B), and the quality data may be taken as an output variable. Further, when an abnormality label is given for each of some sections obtained by dividing the length of the steel plate Pr from which the deformed unsteady parts at the longitudinal-direction head and tail ends have been excluded, a target section can be cut out to obtain an input variable.

The model for performing predictive computation of an output variable from an input variable is constructed such that the input variable and the output variable correspond to each other, that is, a prediction error of the model for performing predictive computation of an output variable from an input variable is minimized. When only record data related to target quality data is used, and the target quality data is used as an output variable, the model is constructed such that the actual target quality data and a predicted output variable correspond to each other. In all the cases, the error is defined as a formula (an error function), and construction (learning) is performed such that the error is minimized. In the case of the AE, the error function may be defined as below, for example.

$$\begin{matrix}[ Math . 3 ] & \\ L ( {x}_{i} , g ( h ( {x}_{i} ) ) ) = RMSE ( {x}_{i} , g ( h ( {x}_{i} ) ) ) + λ ‖ {W}^{1} ‖ & ( 3 )\end{matrix}$$

$$\begin{matrix}[ Math . 4 ] & \\ {W}^{1} = {\sum }_{j = 1}^{J} {\sum }_{k = 1}^{K} {w}_{jk}^{1} & ( 4 )\end{matrix}$$

Here, L indicates a loss function; h indicates an intermediate layer of an NN, g indicates an activation function, W¹ indicates a weight coefficient of the NN of a first intermediate layer, RMSE indicates a root mean square error, and λ indicates a regularization parameter. Here, W¹ is defined by a matrix of the number of input variables j={1, 2, . . . , j} and the number of neurons of the first intermediate layer k={1, 2, . . . , k}. As described above, in the AE, the model for performing predictive computation of an output variable from an input variable is constructed so that the normal data is predicted well. That is, for later detection target data, if there is a deviation between an input variable and an output variable, the data can be judged to be abnormal. It is possible to, by using the loss function described above and using scores indicating relationships, which are defined by Formulas (5) and (6) below, define an abnormality judgment criterion and detect abnormality for an input variable of the later detection target data.

$$\begin{matrix}[ Math . 5 ] & \\ {γ}_{j} = {\sum }_{k = 1}^{K} \vert {w}_{jk}^{1} \vert & ( 5 )\end{matrix}$$

$$\begin{matrix}[ Math . 6 ] & \\ {γ}_{j}^{′} = \frac{{r}_{j} - {r}_{min}}{{r}_{max} - {r}_{min}} ∈ [ 0 , 1 ] & ( 6 )\end{matrix}$$

Here, γⱼ indicates a score indicating a relationship with an input variable j, and γⱼ′ indicates a score indicating a standardized relationship. Using the score γⱼ indicating a relationship, which is calculated from the normal data used for learning, the abnormality judgment criterion can be defined. The abnormality judgment criterion can be set to any numerical value. For example, a method of using the eighth score at the time when scores indicating relationships, which have been calculated from the normal data used for learning, are arranged in descending order, or the like may be adopted, but the abnormality judgment criterion is not limited thereto. Data related to a quality abnormality is detected based on deviations from the abnormality judgment criterion. In the case of the AE, the degree of the deviation Abnormalityⱼ is regarded as “the degree of relationship” in the quality abnormality factor estimation, and is taken by Formula (7) below.

$$\begin{matrix}[ Math . 7 ] & \\ {Abnormality}_{j} = \frac{\text{?} - {r}_{j}}{{r}_{j}^{′}} & ( 7 )\end{matrix}$$

In case of the RF or the SVR, for example, by defining a root mean square error between an input variable and an output variable or a root mean square error between actual target quality data and a predicted output variable as a loss function to construct a model having improved performance of prediction of the normal data, output of data inputted later may be evaluated to detect data related to a quality abnormality. As a method for detecting the data related to the quality abnormality in this case, for example, SHAP (Shapley Additive Explanation) which is a method utilizing a Shapley value may be used. Since the SHAP is a well-known method, it will not be stated in detail here but will be simply described. In the SHAP, how much each input variable has contributed to a prediction result can be indicated, using an average marginal contribution (a Shapley value) among players in a cooperative game in the game theory. When abnormal data is inputted to a model constructed using only the normal data as in the present embodiment, contribution of an abnormal data item is increased, and, the data item can be estimated as a quality abnormality factor.

In the case of using a statistical method as the abnormality factor estimation model, for example, by constructing a representative waveform for each of data items of record data related to target quality data and the quality data in the normal data described above and checking similarity of later detection target data to the representative waveform, a quality abnormality factor can be estimated. The representative waveform may be an average value at each point as shown by Formula (8) below, for example.

$$\begin{matrix}[ Math . 8 ] & \\ {rep}_{j , i} = \frac{1}{N} \cdot {\sum }_{n = 1}^{N} {x}_{j , i} & ( 8 )\end{matrix}$$

Here, rep_{j,i} indicates data at the i-th point of the representative waveform of a data item j. The similarity to the representative waveform may be, for example, similarity in the root mean square error. That is, the larger the numerical value of the root mean square error is, the lower the similarity can be evaluated. By treating similarity similar to the score indicating a relationship in the AE, it is possible to calculate the degree of relationship and estimate a quality abnormality factor.

In all the methods, it is desirable to standardize the input variable for each data item. The standardization may be calculated by the largest or smallest value of the normal data or may be calculated from an average value and a standard deviation. Even for one steel plate Pr, the steel plate length at each measurement point, that is, each measurement position often differs for each of data items of record data related to quality data, and the quality data. Therefore, interpolation of measurement points by approximation or standardization of the steel plate length may also be performed.

Using the information the above-described degree of relationship of which is registered, record data accompanying the steel plate Pr, and the like, quality abnormality factor analysis is supported by the display information generation unit 23. Various screens generated by the display information generation unit 23 are shown in FIG. 5. FIG. 5 is a diagram showing various screens displayed on the HMI apparatus 13 with information generated by the display information generation unit 23. The display information generation unit 23 configures information for displaying a steel plate information list screen 231, a quality abnormality factor estimation result display screen 232, a similar quality abnormality factor estimation/analysis screen 233, and a quality abnormality factor/setting analysis display screen 234, and displays these screens 231 to 234 on the HMI apparatus 13. Steps related to the support for quality abnormality factor analysis will be sequentially described.

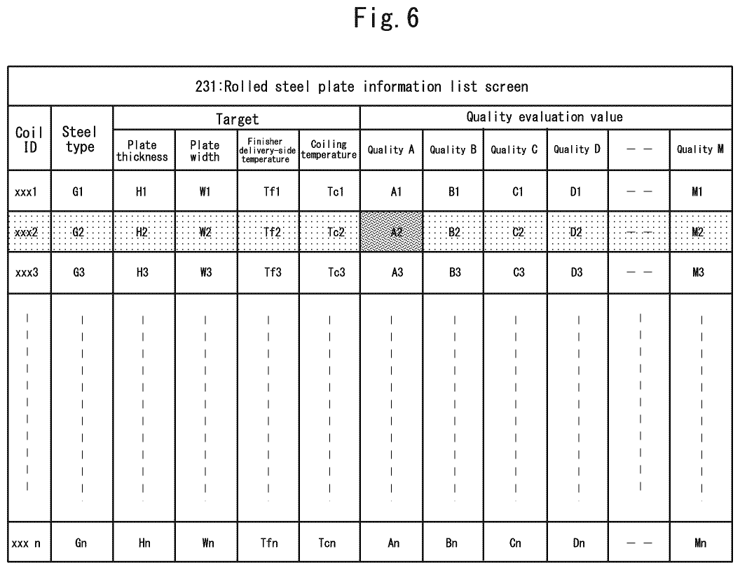

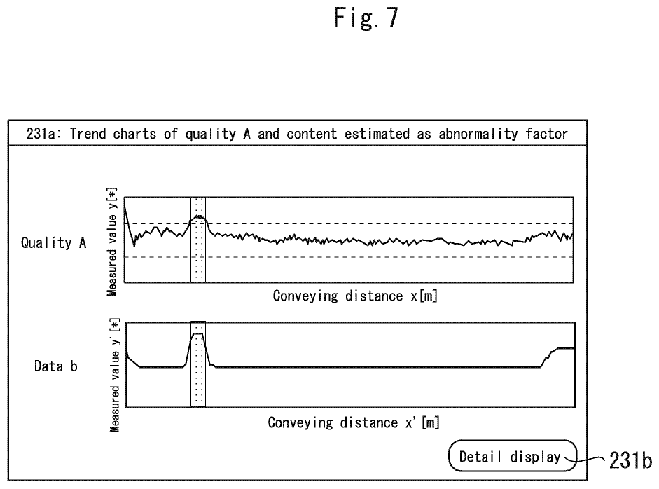

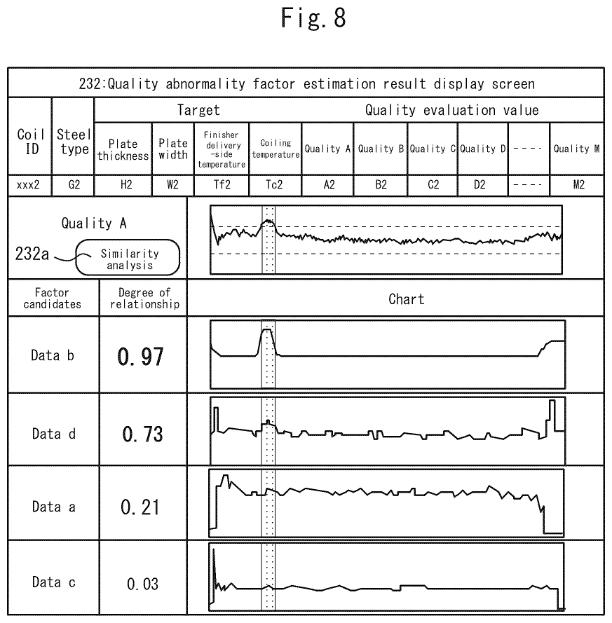

First, on the steel plate information list screen 231, pieces of main product information, such as coil IDs and target plate thicknesses, quality evaluation values, and the like for steel plates are displayed. FIG. 6 is a diagram schematically showing the content of display on the steel plate information list screen 231. The pieces of main product information, such as the coil IDs and the target plate thicknesses, the quality evaluation values, and the like for the steel plates Pr described above are displayed in a table format in which one line corresponds to information about one steel plate Pr (one coil ID). For example, as for a line of a steel plate Pr the quality evaluation value of which exceeds the tolerance like the line of a coil ID “xxx2”, the line may be highlighted, for example, by changing the background color. Further, highlighting such as changing color of a cell or characters of a quality item the quality evaluation value of which exceeds the tolerance (for example, “A2” of the quality A) may be performed. On this screen 231, it is possible to confirm whether or not there is such a steel plate Pr that a quality evaluation value exceeds the tolerance, and confirm quality data thereof. By pressing down a cell of target quality on the line for the steel plate Pr corresponding to the target coil ID “xxx2” (“A2” of the quality A), a screen 231a as shown FIG. 7 is popup-displayed, and a summary of a result of quality abnormality factor estimation of the steel plate Pr can be known. FIG. 7 is a diagram schematically showing the content of display on the screen 231a popup-displayed on the steel plate information list screen 231. Here, “quality A”, which is the target quality data, and “data b”, which is record data related to the target quality and the degree of relationship of which is the highest among quality abnormality factor estimations, are displayed as trend charts. Here, a position at which the tolerance of the target quality is exceeded is highlighted by being shaded in FIG. 7, and it is possible to confirm where (at which position) on the steel plate Pr the tolerance is exceeded. Though only the data b with the highest degree of relationship is displayed as the target quality abnormality factor on the screen 231a, it is possible to, by pressing down a detail display button at a lower part of the popup screen 231a, transition to the quality abnormality factor estimation result display screen 232 shown in FIG. 8 and confirm details of a quality abnormality factor estimation result for the target quality of the steel plate Pr.

FIG. 8 is a diagram schematically showing the content of display on the quality abnormality factor estimation result display screen 232. On the quality abnormality factor estimation result display screen 232, the details of the quality abnormality factor estimation result of the steel plate Pr (coil ID: xxx2) selected on the steel plate information list screen 231 described above, for the target quality A are displayed. A list of main product information, such as a coil ID and a target plate thickness, quality evaluation values, and the like for the steel plate Pr, and trend charts of target quality data are displayed. Among quality abnormality factor estimation results of target quality data, pieces of record data related to the target quality A with high degrees of relationships are displayed as trend charts. The pieces of record data related to the target quality A with the high degrees of relationships are displayed in descending order of the degrees of relationships, and it is possible to confirm data that is thought to be a quality abnormality factor early. Further, it is also possible to, by scrolling the screen, sequentially confirm pieces of data with low degrees of relationships. Similarly to the popup screen 231a on the steel plate information list screen 231 described above, a position at which the tolerance of the target quality A is exceeded is highlighted by shading in the charts, and it is possible to confirm where on the steel plate the tolerance is exceeded. Since the pieces of record data with the high degrees of relationships and the position at which the tolerance is exceeded can be confirmed at a glance, the user can easily find measures for quality improvement if he is an expert who has been engaged in a hot rolling line for a long time. Even if the user is not an expert, he can early proceed to the next action such as reporting of problems and transfer of measures because pieces of data with high degrees of relationships are displayed first.

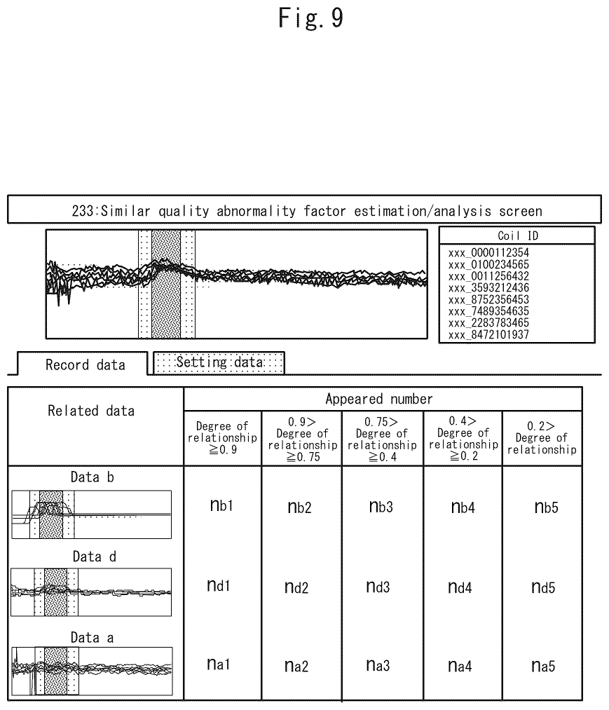

Furthermore, by pressing down a similarity analysis button 232a on the quality abnormality factor estimation result display screen 232, it is possible to transition to the similar quality abnormality factor estimation/analysis screen 233 shown in FIG. 9. FIG. 9 is a diagram schematically showing the content of display on the similar quality abnormality factor estimation/analysis screen 233. On the similar quality abnormality factor estimation/analysis screen 233, a “record data” tab button is pressed down. On the similar quality abnormality factor estimation/analysis screen 233, it is possible to perform comparison/analysis of quality abnormality factor estimation results, relative to other steel plates Pr for which quality abnormality characteristics similar to those of the steel plate Pr selected on the steel plate information list screen 231 described above are registered. Pieces of target quality data of the steel plates for which the similar quality abnormality characteristics are registered are collectively displayed as trend charts in the same graph field. Coil IDs of the steel plates (eight coil IDs in FIG. 9) are simultaneously shown. A function that is more specialized in visualization may be given, such as only a trend chart of a corresponding steel plate Pr being highlighted by any of the coil IDs being pressed down. At the same time, pieces of record data related to abnormality of the target quality are displayed as trend charts in a list. Though, similarly to the quality abnormality factor estimation result display screen 232 described above, a position at which the tolerance of the target quality is exceeded (a quality abnormality occurrence position) on the trend charts of the target quality data and the related record data is highlighted by being shaded in FIG. 9, a range of the position may be displayed in a different color, for example, according to whether the value is a minimum value, a maximum value, an average value, or the like. Distributions of degrees of relationships for the pieces of data b, d, and e, respectively, are also displayed in a list. Though the distributions of the degrees of relationships for the pieces of data, respectively, are displayed in a table as numerical values of the number of steel plates that have appeared, in FIG. 9, the numerical values may be highlighted by shades of background color or the like in descending order of the numerical values. Or alternatively, the distributions may be displayed as a histogram chart.

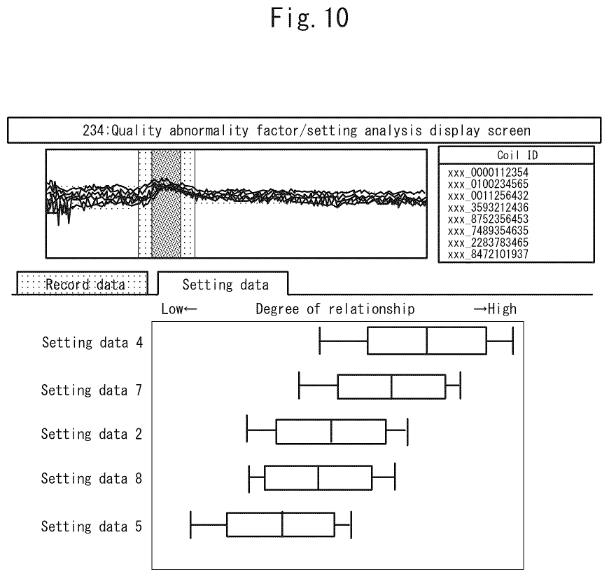

By pressing down a “setting data” tab button on the similar quality abnormality factor estimation/analysis screen 233, it is possible to transition to the quality abnormality factor/setting analysis display screen 234 shown in FIG. 10. FIG. 10 is a diagram schematically showing the content of display on the quality abnormality factor/setting analysis display screen 234. On the quality abnormality factor/setting analysis display screen 234, not only record data related to a target quality abnormality but also setting data can be analyzed. For example, by charting the degrees of relationships of design values 4, 7, 2, 8, and 5 as factor candidates relative to setting data as a box beard diagram, it is made possible to support analysis about a target quality abnormality and the setting data.

By confirming similar quality abnormalities and the factor estimation results thereof for many steel plates Pr as above, it is possible to support analysis of whether or not the quality abnormality constantly occurs, whether or not the quality abnormality always occurs due to the same factor, whether the quality abnormality suddenly occurs under a particular condition such as related setting data in addition to a steel type and a target plate thickness, and the like. The trend charts for the whole length of a steel plate Pr are shown on all the screens, but, when a quality evaluation value is calculated for each of sections obtained by dividing the length of the steel plate Pr from which the deformed unsteady parts at the head and tail ends in the longitudinal direction are excluded, a chart corresponding to a target section may be shown. Further, since setting values are set before rolling, occurrence of a quality abnormality can be prevented by analyzing setting values estimated as factor candidates before rolling, based on degrees of relationships. By combining this with quality abnormality analysis based on time-series data (record data) after rolling, usability for the user can be improved.

As described above, according to the present embodiment, it is possible to, by obtaining a quality abnormality position at which a quality evaluation value of an abnormal product exceeds a tolerance, display at which position in the longitudinal direction of the product the quality abnormality has occurred. Furthermore, by constructing a quality abnormality factor estimation model using normal data, estimating candidates for the factor of the quality abnormality using the constructed quality abnormality factor estimation model, and calculating degrees of relationship of the estimated factor candidates with the quality abnormality, it is possible to display time-series data with a high degree of relationship as the factor of the occurrence of the quality abnormality. Therefore, it is possible to provide a quality abnormality factor analysis support system capable of, when a product is judged to have a quality abnormality, displaying at which position in the longitudinal direction of the product the quality abnormality has occurred and displaying the factors of the occurrence.

### Second Embodiment

Next, description will be made on a second embodiment of the present disclosure, mainly on points different from the first embodiment described above. In the first embodiment described above, construction of a quality abnormality factor estimation model is performed only at a timing when the conditions described above are satisfied or at an arbitrary timing decided by the user (including the administrator) of the quality abnormality factor analysis support system 20. It is difficult to cover all quality abnormality patterns of the rolling plant 1 only by constructing a quality abnormality factor estimation model at such a timing, that is, only by a data set at the timing.

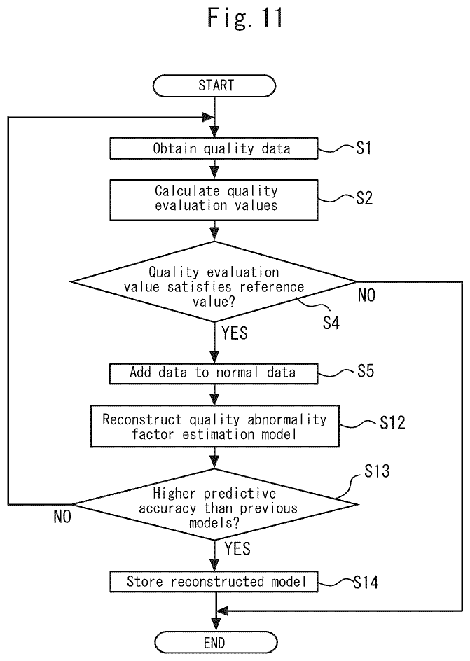

The present embodiment is characterized in constructing the quality abnormality factor estimation model described above at each timing when rolling of a steel plate Pr is completed after the above timing. FIG. 11 is a diagram showing a process flow of the quality abnormality factor analysis support system according to the second embodiment.

A routine shown in FIG. 11 is activated each time rolling is completed. In the present routine, similarly to the routine shown in FIG. 3, pieces of quality data xi are obtained (step S1), and quality evaluation values are calculated (step S2). After that, it is judged whether or not each quality evaluation value deviates from the tolerance, which is the reference value (step S4). The process so far is similar to that of the first embodiment.

In the present embodiment, when the quality evaluation value of the steel plate Pr is judged to be within the tolerance at step S5 above, a label is registered as being normal data (step S5), and data of the steel plate Pr is newly added to the normal data used at the time of constructing a model last to reconstruct a quality abnormality factor estimation model (step S12). Next, an error calculated from the loss function of the quality abnormality factor estimation model reconstructed at step S12 above and an error calculated from the loss function of the model constructed last are compared (S13); and, if the error of the reconstructed model is smaller, the reconstructed quality abnormality factor estimation model is stored (step S14).

According to the present embodiment, it is possible to, by reconstructing a quality abnormality factor estimation model each time rolling is completed, after constructing a quality abnormality factor estimation model in the first embodiment described above, update the quality abnormality factor estimation model. Thereby, reproducibility of an input variable or performance of prediction of target quality data is improved, and it becomes possible to always estimate a quality abnormality factor using a quality abnormality factor estimation model corresponding to the state of the latest rolling plant 1. Further, by, when a predicted error of a reconstructed quality abnormality factor estimation model is smaller than a predicted error of a currently used quality abnormality factor estimation model before the reconstruction, updating the quality abnormality factor estimation model (storing the model into the data storage unit 21), it is possible to prevent decrease in accuracy due to reconstruction of the model.

Though a model is reconstructed each time rolling is completed in the present embodiment, the reconstruction timing is not limited thereto and may be appropriately set by the user. For example, when the user feels uncomfortable at the time of confirming the quality abnormality factor estimation result display screen 232, a model can be reconstructed. Thereby, the accuracy can be improved.

FIG. 12 is a diagram showing an example of the hardware configuration of the quality abnormality factor analysis support system 20. Each of the above functions of the quality abnormality factor analysis support system 20 can be realized by a processing circuit shown in FIG. 12. The processing circuit 20 may be dedicated hardware 20a. The processing circuit may be provided with the processor 20b and the memory 20c. The processing circuit may be such that a part thereof is formed as the dedicated hardware 20a, and the processor 20b and the memory 20c are further provided. In the example of FIG. 12, a part of the processing circuit 20 is formed as the dedicated hardware 20a, and the processing circuit 20 is also provided with the processor 20b and the memory 20c. The processing circuit 20 may be at least one piece of dedicated hardware 20a. In this case, as the processing circuit 20, for example, a single circuit, a composite circuit, a programmed processor, a parallel-programmed processor, an ASIC, an FPGA, or a combination thereof corresponds. The processing circuit 20 may be at least one processor 20b and at least one memory 20c. In this case, each of the functions of the quality abnormality factor analysis support system 20 is realized by software, firmware, or a combination of software and firmware. The software and the firmware are written as programs and stored in the memory 20c. The processor 20b realizes each of the functions of the quality abnormality factor analysis support system 20 by reading out and executing the programs stored in the memory 20c. The processor 20b is also called a CPU (Central Processing Unit), a processing apparatus, an arithmetic apparatus, a microprocessor, a microcomputer, or a DSP. As the memory 20c, a storage device, such as a non-volatile or volatile semiconductor memory, for example a RAM, a ROM, a flash memory, an EPROM, or an EEPROM, corresponds. The memory 20c can also serve as the database DB. Thus, the processing circuit 20 can realize each of the functions of the quality abnormality factor analysis support system 20 by hardware, software, firmware, or a combination thereof.

The embodiments of the present invention have been described above. The present invention, however, is not limited to the embodiments described above, and may be variously modified and practiced within a range not departing from the spirit of the present invention. In the embodiments described above, a configuration is made in which information generated by the display information generation unit 23 is transmitted to the HMI apparatus 13, and the various screens 231, 232, 233, and 234 are displayed on the HMI apparatus 13. However, a configuration may be made in which a display unit is provided inside the quality abnormality factor analysis support system 20, and the various screens are displayed on the display unit.

Further, in the embodiments described above, when a numerical value such as the number of for each component, a quantity, an amount, or a range is mentioned, the present invention is not limited to the mentioned numerical value unless expressly otherwise indicated, or the numerical value is clearly identified in principle. Further, the structures and the like described in the embodiments described above are not necessarily indispensable for the present invention unless expressly otherwise indicated, or they are clearly identified in principle.

### REFERENCE SIGNS LIST

1 . . . rolling plant, 13 . . . . HMI apparatus (display unit), 20 . . . quality abnormality factor analysis support system, processing circuit, 20a . . . dedicated hardware, 20b . . . processor, 20c . . . memory, 21 . . . data storage unit, 22 . . . quality abnormality factor estimation/calculation unit, 23 . . . display information generation unit, 231 . . . steel plate information list screen, 232 . . . quality abnormality factor estimation result display screen, 233 . . . similar quality abnormality factor estimation/analysis screen, 234 . . . quality abnormality factor/setting analysis display screen

1. A quality abnormality factor analysis support system comprising:
data storage circuitry;
quality abnormality factor estimation/calculation circuitry; and
display information generation circuitry, wherein
the data storage circuitry configured to store manufacturing conditions for products manufactured in a rolling plant, setting conditions for facilities and equipment installed in the rolling plant, and time-series data at time of manufacture as record data acquired from measurement equipment installed in the rolling plant;
the quality abnormality factor estimation/calculation circuitry configured to execute
calculating quality evaluation values from quality data about product qualities of the products selected from the time-series data at the time of manufacture,
regarding such products or a product group that the calculated quality evaluation values exceed a tolerance as abnormal products,
obtaining quality abnormality positions of the abnormal products at which the tolerance is exceeded,
registering the time-series data, the manufacturing conditions, and the setting conditions about a normal product group that the quality evaluation values are within the tolerance as normal data,
constructing a quality abnormality factor estimation model based on the time-series data registered as the normal data or based on the manufacturing conditions and the setting conditions registered as the normal data, the quality abnormality factor estimation model using machine learning or a statistical method,
estimating factor candidates of the quality abnormality from the time-series data or from the manufacturing conditions and the setting conditions, based on the constructed quality abnormality factor estimation model, and
calculating degrees of relationship of the estimated factor candidates with the quality abnormality; and
the display information generation circuitry configured to generate information for displaying, on a display, the quality data of the abnormal products, the quality abnormality positions, the time-series data, or the manufacturing conditions and the setting conditions, and the factor candidates and the degrees of relationship estimated and calculated by the quality abnormality factor estimation/calculation circuitry.

2. The quality abnormality factor analysis support system according to claim 1, wherein
the display information generation circuitry generates information for displaying the manufacturing conditions, the setting conditions, the quality evaluation values, and the quality abnormality positions, for the abnormal products, in a list.

3. The quality abnormality factor analysis support system according to claim 1, wherein
the display information generation circuitry generates information for displaying trend charts of the quality data of the abnormal products, a trend chart of the time-series data corresponding to the factor candidate with a highest degree of relationship among the factor candidates estimated by the quality abnormality factor estimation/calculation circuitry, and the quality abnormality positions in each of the trend charts.

4. The quality abnormality factor analysis support system according to claim 1, wherein
the display information generation circuitry generates information for displaying trend charts of the quality data of the abnormal products, the plurality of factor candidates estimated by the quality abnormality factor estimation/calculation circuitry, the degree of relationship of each factor candidate, a trend chart of the time-series data corresponding to each factor candidate, and the quality abnormality positions in each of the trend charts.

5. The quality abnormality factor analysis support system according to claim 1, wherein
the display information generation circuitry generates, for the abnormal products the quality data and quality abnormality positions of which are the same, information for displaying the setting conditions as the factor candidates and degrees of relationships of the setting conditions with the quality abnormality.

6. (canceled)

7. The quality abnormality factor analysis support system according to claim 1, wherein
the quality abnormality factor estimation/calculation circuitry reconstructs the quality abnormality factor estimation model each time each of the products is manufactured, and, when a predicted error of the reconstructed quality abnormality factor estimation model is smaller than a predicted error of the quality abnormality factor estimation model before the reconstruction, updates the quality abnormality factor estimation model.
